(19) United States
(12) Patent Application Publication
(10) Pub. No.: US 2014/0055462 A1
(43) Pub. Date: Feb. 27, 2014

(54) METHOD OF DEFINING IMAGE SURVEILLANCE REGION

(71) Applicant: TRIPLE DOMAIN VISION CO., LTD., Hsinchu County (TW)

(72) Inventors: Yi-Pin Hsu, Taitung County (TW); Ching-Tien Lin, Hsinchu (TW); Maik Tzonchon Maa, Taipei City (TW); Kung-Ming Lan, Miaoli County (TW)

(73) Assignee: TRIPLE DOMAIN VISION CO., LTD., Hsinchu County (TW)

(21) Appl. No.: 13/726,035

(22) Filed: Dec. 22, 2012

(30) Foreign Application Priority Data
Aug. 22, 2012 (TW) 101130469

(51) Int. Cl. G06T 11/00

(52) U.S. Cl. CPC G06T 11/00
USPC 345/441

(57) ABSTRACT

A method for defining a monitoring area for an image is provided, applicable to an image-based surveillance system, including the steps of: automatically generating a closed polygon on an image; determining whether the closed polygon requiring adjustment, if so, receiving an adjustment command from the user and performing corresponding adjustment . The adjustment commands include at least a move polygon command to move the entire polygon and a move vertex command to move a vertex of the polygon.

### FIELD OF THE INVENTION

The present invention generally relates to a method of image monitoring region, and more specifically to a method of defining image monitoring region, able to automatically generate an adjustable image monitoring region, applicable to a continuous image-based surveillance system.

### BACKGROUND OF THE INVENTION

As the digital image capturing equipment becomes popular, the image-based surveillance is widely applied to many fields, such as, crisis prevention in mountains, forestry, dam, ocean, and so on, or security surveillance of building and houses, traffic or even assembly line conveyors. The amount of captured environmental images is increasingly growing. Therefore, to improve the effectiveness of captured environmental images, different surveillance techniques are developed, including the designation of surveillance region. The image surveillance region is designated by the user through an interface to define a region of interest (ROI) in the image captured by surveillance camera. When the image of the designated region changes or suspicious object appearing in the monitored designated region, the operator is automatically notified to judge the appearing object or changed image and take appropriate action. On the other hand, the defining of ROI can also be applied to inspecting a large amount of storied captured images after the event had occurred to accelerate the efficiency of image search for event-related images.

As aforementioned, the conventional ROI definition technique usually involves an operation interface, and the system automatically performs or the user inputs parameters to perform image calibration. Then, the user can use the interface to input parameters or draw directly at least a trigger line to accomplish the defining of ROI.

### SUMMARY OF THE INVENTION

The primary object of the present invention is to provide a method of defining monitoring region, applicable to an image-based surveillance system, able to generate automatically a polygonal closed region as an image monitoring area on a planar image in accordance with the resolution of the planar image so as to improve convenience of image-base surveillance.

Another object of the present invention is to provide a method of defining monitoring region, applicable to an image-based surveillance system, able to adjust the automatically generated polygonal image monitoring area to improve flexibility of image-based surveillance.

To achieve the above objects, the present invention provides a method of defining monitoring region, applicable to an image-based surveillance system, including the steps of: automatically generating a polygonal closed region on a planar image; determining whether finishing defining; if so, the method terminates; otherwise, receiving adjustment commands from a user and adjusting according to the commands, and returning to the step of determining whether finishing defining.

According to a preferred embodiment, the step of automatically generating a polygonal closed region on a planar image further includes: preparing a planar image; according to the resolution of the planar image, automatically generating a default polygonal closed region; and overlapping the automatically generated polygonal closed region onto the planar image.

According to a preferred embodiment, the adjustment commands at least includes: a move region command for moving the entire polygonal closed region, and a move vertex command for moving a vertex of the polygonal closed region, and the step of receiving adjustment commands from a user and adjusting according to the commands further includes: if the adjustment command is a move region command, the entire polygonal closed region is moved; if the adjustment command is a move vertex command, the vertex is moved and the two edges linked to the vertex are adjusted to maintain the polygonal as a closed region.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

The present invention can be understood in more detail by reading the subsequent detailed description in conjunction with the examples and references made to the accompanying drawings, wherein:

FIG. 1 shows a flowchart of the method of defining image monitoring region according to the present invention;

FIG. 2 shows a flowchart of the step of automatically generating a polygonal closed region according to the present invention;

FIG. 3 shows a flowchart of the step of receiving adjustment commands from a user and adjusting according to the commands of the present invention;

FIG. 4 shows a schematic view of an embodiment of an automatically generated adjustable image monitoring region according to the present invention;

FIG. 5 shows a schematic view of an embodiment of executing an adjustment command on an automatically generated adjustable image monitoring region according to the present invention; and

FIG. 6 shows a schematic view of another embodiment of executing an adjustment command on an automatically generated adjustable image monitoring region according to the present invention.

### DETAILED DESCRIPTION OF THE PREFERRED EMBODIMENTS

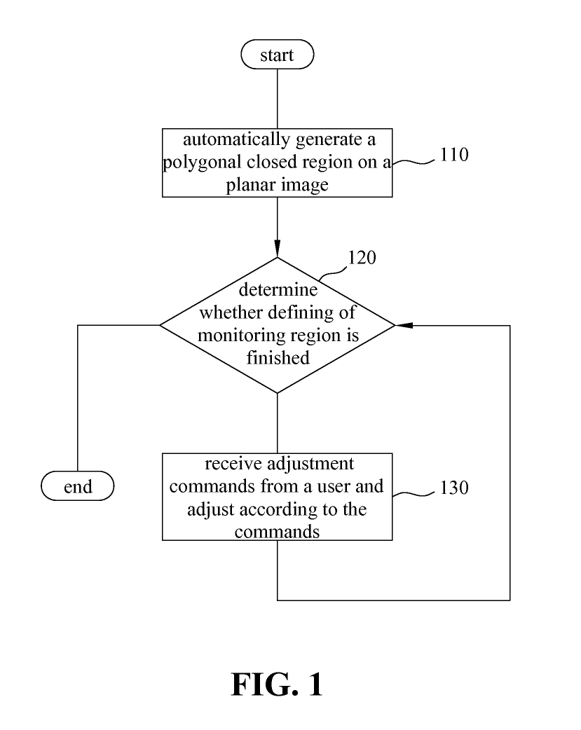

FIG. 1 shows a flowchart of the method of defining image monitoring region according to the present invention, applicable to an image-based surveillance system. As shown in FIG. 1,

Step 110 is for the surveillance system to automatically generate a polygonal closed region on a planar image. The planar image can be an image frame captured by the surveillance system using a camera, image frame stored in the surveillance system, or image frame inputted to the surveillance system through other means. For the polygonal closed region, the number of edges, the region size, shape and the location on the planar image are all automatically generated according to default values or other means of the surveillance system. Step 120 is to determine whether the defining of monitoring region is finished; if so, the method terminates; otherwise, the method proceeds to step 130 for receiving adjustment commands from a user and adjusting according to the commands, and returning to step 120 to determine whether the defining of monitoring region is finished.

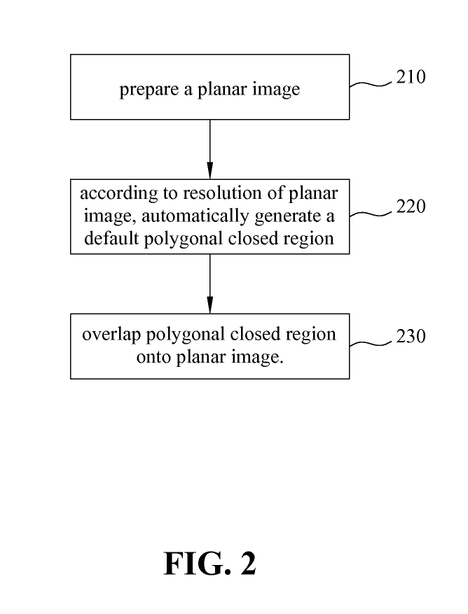

FIG. 2 shows a flowchart of the step of automatically generating a polygonal closed region on a planar image according to the present invention. As shown in FIG. 2, the step of automatically generating a polygonal closed region on a planar image further includes: preparing a planar image, as shown in step 210. As aforementioned, the planar image can be an image frame captured by the surveillance system using a camera, image frame stored in the surveillance system, or image frame inputted to the surveillance system through other means. Step 220 is to, according to the resolution of the planar image, automatically generate a default polygonal closed region. In step 220, if the resolution of the planar image is too small, for example, smaller than a default resolution, the system can either terminate the process or issue a warning signal to suggest the user to prepare a planar image with sufficient resolution. This is because when the resolution is too small, the detection accuracy may suffer due to false alarm as the sensitivity or the error is too large. In addition, for the polygonal closed region, the number of edges, the region size, shape and the location on the planar image can all be determined according to the resolution of the planar image to improve the detection efficiency of the automatically generated monitoring region. Finally, in step 230, the automatically generated polygonal closed region is place over the planar image. The polygonal can be displayed with bright color line with sufficient width to improve readability and adjustment convenience.

It should be noted that the adjustment commands in step 130 at least includes a move region command for moving the entire polygonal closed region, and a move vertex command for moving a vertex of the polygonal closed region. The move region command does not change the size, the shape, or the number of edges of the polygonal closed region. The move vertex command, however, moves the selected vertex only and the other vertices remain unmoved. Therefore, the move vertex command may change the size, the shape, or the number of edges of the polygonal closed region.

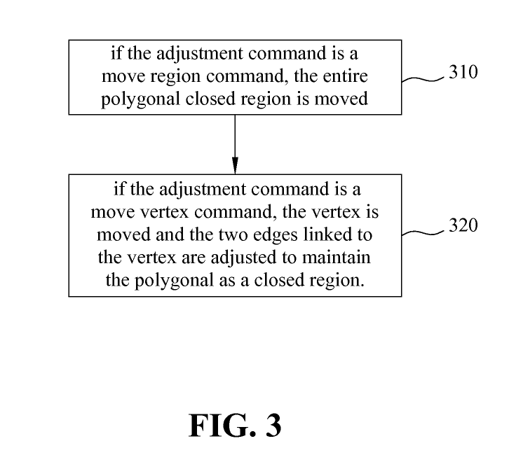

FIG. 3 shows a flowchart of the step of receiving adjustment commands from a user and adjusting according to the commands. As shown in FIG. 3, in step 310, if the adjustment command is a move region command, the entire polygonal closed region is moved; and in step 320, if the adjustment command is a move vertex command, the vertex is moved and the two edges linked to the vertex are adjusted to maintain the polygonal as a closed region. It should be noted that the manner the user selects adjustment commands includes at least: directly click and drag the vertex or edge of the polygonal closed region, and input parameters through an interface. After executing the adjustment command, the method returns to the step of determining whether the defining of the image monitoring region is finished. In addition, during moving the region or the vertex, a restrictive step can be included to ensure that the polygonal closed region will not exceed the boundary of the planar image.

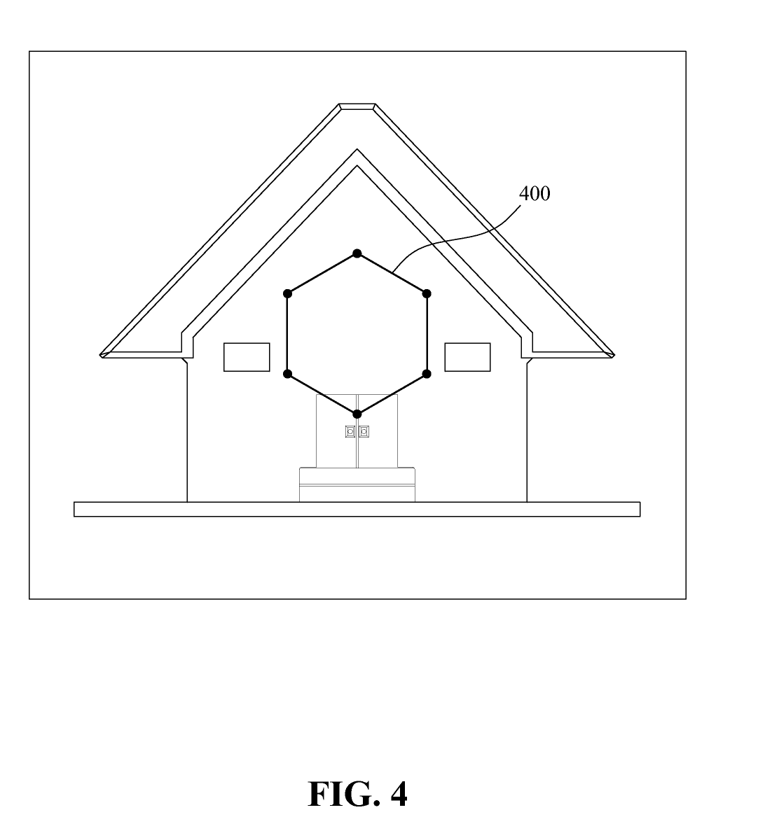

FIG. 4 shows a schematic view of an exemplary embodiment of the automatically generated image monitoring region according to the present invention. In the present embodiment, the automatically generated image monitoring region is a right hexagonal region placed at the center of the planar image. As shown in FIG. 4, the automatically generated hexagonal image monitoring region 400 appears at the center region of the planar image. It should be noted that the automatically generated image monitoring region can be of any shape, any size or overlapping onto the planar image at any location.

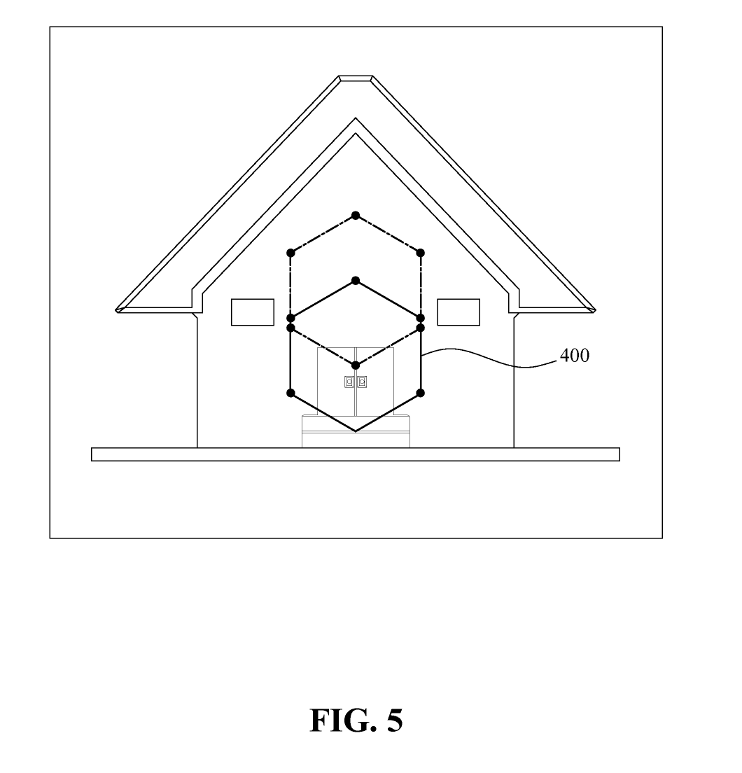

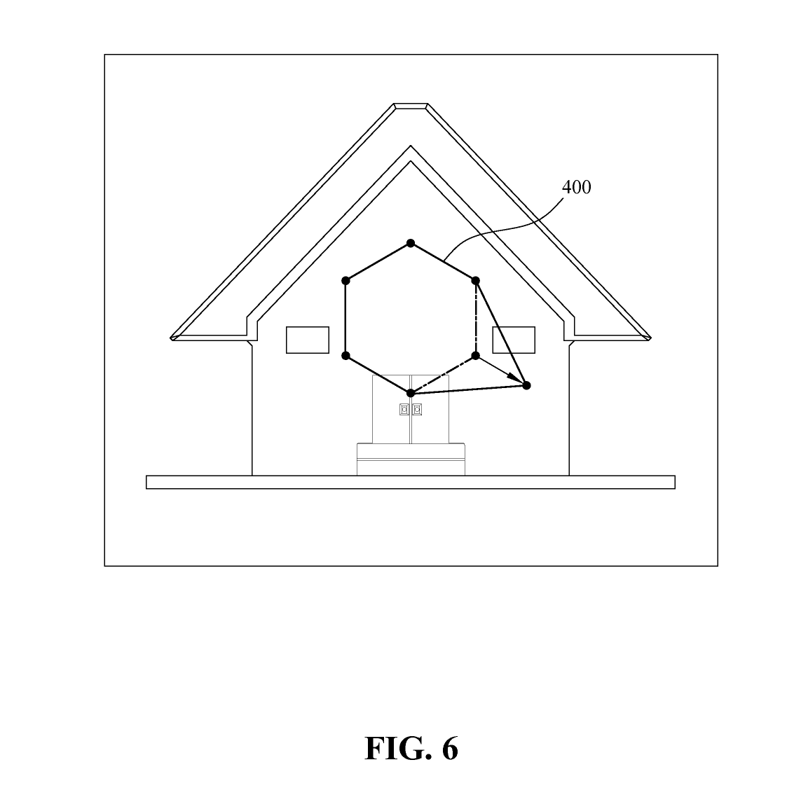

FIG. 5 and FIG. 6 show the schematic views of the embodiment of adjustment command respectively. FIG. 5 shows the execution of move region command and FIG. 6 shows the execution of move vertex command, wherein the two edges linked by the moved vertex are also adjusted to maintain the closure of the polygonal region.

Compared to the conventional technique, the present invention has the following advantages:

1. Ability to automatically generate a polygonal closed region on a planar image as an image monitoring region according to the resolution of the planar image to improve image-based surveillance convenience.

2. Ability to adjust the automatically generated polygonal monitoring region to improve flexibility of image-based surveillance.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A method of defining monitoring region, applicable to an image-based surveillance system, comprising the steps of:
automatically generating a polygonal closed region on a planar image;
determining whether finishing defining; and
if so, the method terminates; otherwise, receiving adjustment commands from a user and adjusting according to said adjustment commands, and returning to said step of determining whether finishing defining.

2. The method of defining monitoring region as claimed in claim 1, wherein said step of automatically generating a polygonal closed region on a planar image further comprises:
preparing a planar image;
according to resolution of said planar image, automatically generating a default polygonal closed region; and
overlapping said automatically generated polygonal closed region onto said planar image.

3. The method of defining monitoring region as claimed in claim 2, wherein number of edges, region size, shape or location on said planar image of said polygonal region can be automatically generated according to default values of said surveillance system, resolution of said planar image or other means.

4. The method of defining monitoring region as claimed in claim 1, wherein said adjustment commands at least comprises: a move region command for moving said entire polygonal closed region, and a move vertex command for moving a vertex of said polygonal closed region;
wherein said move region command does not change size, shape, or number of edges of said polygonal closed region, and said move vertex command, however, moves a selected vertex only and other vertices remain unmoved; hence said move vertex command may change size, shape, or number of edges of said polygonal closed region.

5. The method of defining monitoring region as claimed in claim 1, wherein said step of receiving adjustment commands from a user and adjusting according to the commands further comprises:
if said adjustment command is a move region command, said entire polygonal closed region is moved; and
if said adjustment command is a move vertex command, said vertex is moved and two edges linked to said vertex are adjusted to maintain said polygonal as a closed region.

6. The method of defining monitoring region as claimed in claim 5, further comprising a restrictive step of ensuring said polygonal closed region not exceeding boundary of said planar image during moving said region or said vertex.
